(19) United States
(12) Patent Application Publication
(10) Pub. No.: US 2022/0188482 A1
(43) Pub. Date: Jun. 16, 2022

(54) METHOD FOR ACQUIRING AND PROCESSING ELEVATOR DATA OF AN ELEVATOR SYSTEM

(71) Applicant: INVENTIO AG, Hergiswil (CH)

(72) Inventor: Elena CORTONA, Zürich (CH)

(21) Appl. No.: 17/600,045

(22) PCT Filed: May 4, 2020
(86) PCT No.: PCT/EP2020/062294

§ 371 Date: Sep. 29, 2021

(30) Foreign Application Priority Data
May 7, 2019 (EP) 19173039.9
May 27, 2019 (EP) 19176791.2

(51) Int. Cl. G06F 30/20; G06F 30/12; G06F 30/13

(52) U.S. Cl. CPC G06F 30/20; G06F 2111/16; G06F 30/13; G06F 30/12

(57) ABSTRACT

Methods and devices for optimizing control data of the elevator control unit of an existing or modernized elevator installation are described. An elevator control unit is connected to a programmable device. A three-dimensional digital replica data record, which can be generated by a computer program product, is loaded onto the programmable device as a simulation environment. The three-dimensional digital replica data record maps and simulates the existing or modernized elevator installation assigned to the elevator control unit. By testing the elevator control unit in the simulation environment, a parameter set for the elevator control unit of the existing or modernized elevator installation, which is matched for operation in the simulation environment, can be determined.

### TECHNICAL FIELD

The disclosure relates to optimizing control data for an elevator control unit of an existing elevator installation or an elevator installation to be modernized.

### SUMMARY

Elevator installations are used to transport people inside buildings or structures. In order for an elevator installation to function properly, a parameter set having very precise control data that is matched to the configuration-related peculiarities of the elevator installation is required for the elevator control unit thereof. This is the only way the elevator cab of the elevator installation can move to the correct positions and offer a high level of driving comfort for its users. Elevator manufacturers usually offer a plurality of product lines that differ significantly in their structure, but may use a similar elevator control unit. It is the same because, although the control hardware and the control software of the elevator control unit are the same for all product lines, different parameter sets that take into account the technical differences of the product lines are used for the control software.

Different parameter sets are not only required for the different product lines. In fact, each customer installation is also different for an elevator installation of a product line (standard product), since customer-specific configuration data such as the floor heights, the size of the elevator cab, the mass to be transported, the travel speed etc. are very variable in order to meet the needs of the customers who operate such an elevator installation. Regulations from standards such as the maximum acceleration and deceleration of the elevator cab also determine the parameter sets.

When testing a product line, a “representative” configuration is usually selected, and the tests are carried out using this test installation with this special configuration. The results or the parameter set of the test installation determined for the elevator control unit are then extrapolated to the entire application area of the product line. As there are a limited number of test towers available, for example, for a product line having a delivery head of up to 50 meters, only one test tower having a delivery height of 30 meters can be available. Accordingly, a test installation having a delivery head of 30 meters is configured from the product line and tested to determine the parameter set. Then the results are extrapolated to all possible configurations of the product line. However, practice shows that when modernizing newly installed elevator components with a delivery head other than the tested delivery head, configuration-related problems such as vibration problems and thus noise problems may arise, and thus the extrapolation of the results does not always lead to an ideal parameter set for the elevator control unit. Correcting these problems by adapting the parameter set requires highly qualified personnel on site and delays the handover of the completed elevator installation.

The documents XP055647213 and XP055647212 describe the development of products with the help of the “Hardware in the Loop approach.” Control data are tested and determined using a configurable simulation model as a simulation environment. Even if this approach already produces very realistic results, these results are still dependent on the configuration quality of the simulation model. In the event of deviations, post-processing costs may arise for an existing elevator installation or an elevator installation to be modernized, which must be carried out by tests on the construction site.

Existing elevator installations are also not necessarily maintained by the elevator manufacturer itself. For a variety of reasons, it may happen that so-called external installations, e.g., elevator installations from other elevator manufacturers, are incorporated into the elevator owner's own maintenance portfolio and serviced. If necessary, such external installations are modernized, so that components from different manufacturers are subsequently adapted to one another and installed in a modernized elevator installation. In such external installations, for example, the existing third-party elevator control system is replaced by an in-house elevator control unit, since the architecture and properties of the in-house elevator control unit are known and no special knowledge of the third-party elevator control unit needs to be acquired. However, various characterizing properties of the existing elevator installation, such as the number of floor levels, the floor heights, the motion profiles of the elevator cab adjusted to the mechanical and electrical components via the individual floor heights and the like, must be recorded and a parameter set corresponding to these characterizing properties must be determined for the in-house elevator control unit. In particular, it may be desirable for the modernization of the existing elevator installation to also revise the motion profiles of the elevator cab and not simply adopt them from the old elevator control unit.

If an external installation is added to the maintenance portfolio, there is always the problem of recording the data of this existing elevator installation and making it available. A technician is usually sent to the external installation to be adopted who then determines various characterizing properties of this elevator installation and manually records them in a form or in a database. Depending on the complexity of an elevator installation to be adopted, 15 to 50 characterizing properties, for example, have to be manually entered in the form of characterizing properties in the form or in the database. The manual recording of the characterizing properties and their documentation in the database requires an enormous amount of time and, depending on the quality of work of the technician, can lead to poor data quality, and subsequently lead to an inadequate parameter set when extrapolating, which in turn has to be adapted to the existing elevator installation with great effort on site and impairs its availability for the customer.

An object of the present disclosure is therefore to determine, for the elevator control unit of a specific elevator installation, a parameter set which is matched as precisely as possible to this elevator installation, without the specific elevator installation being available for this.

This object can be achieved by a method for optimizing control data for the elevator control unit of an existing elevator installation or an elevator installation to be modernized, wherein the elevator control unit is connected to a programmable device. A three-dimensional digital replica data record is loaded onto the programmable device as a simulation environment and can be generated by means of a computer program product. The three-dimensional digital replica data record maps and simulates the existing elevator installation or the elevator installation to be modernized which is assigned to the elevator control unit. As a result, a parameter set for operation of the elevator control unit of the existing or modernized elevator installation, which is coordinated for operation in the simulation environment, can be determined by testing the elevator control unit in the simulation environment.

The three-dimensional digital replica data record of the existing or modernized elevator installation is constructed from component model data records by means of the computer program product and stored in a storage medium, the component model data records being able to have different configurations and being defined by characterizing properties. Each characterizing property of a component model data record is predefined by a default value, by a target value, or by an actual value. A component model data record usually depicts a physical component in its entirety, which can mean that the information that provides the characterizing properties reproduces the physical component in virtual form as precisely as possible. In other words, the characterizing properties can relate to individual components from which larger, more complex component groups are composed.

Characterizing properties of a component model data record in the sense of the present disclosure can be geometric dimensions, surface properties, physical properties, dynamic properties, and the like of the component represented by them. Geometric dimensions can be, for example, a length, a width, a height, a cross section, radii, fillets, etc. of the components. The surface quality of the component can include, for example, roughness, textures, coatings, colors, reflectivities, etc. Physical properties can be the weight or the material density, the modulus of elasticity, the conductivity, the moment of inertia, the bending strength value, and the like. Dynamic properties can be degrees of freedom of motion associated with the component model data record, speed profiles and the like.

The characterizing properties can relate not only to individual components, but also to component groups in self-contained subsystems. In other words, the characterizing properties may also refer to more complex equipment composed of a plurality of components, such as drive motors, gear units, conveyor chains, etc.

Default values in the sense of the present disclosure are values which predefine the characterizing properties of a component model data record. This can mean, for example, that a default value of a component model data record configured as a guide rail component model data record, which maps a guide rail, defines a standard length in the sense of a placeholder. The cross-sectional shape of this guide rail component model data record can also be predefined by default values. It is now obvious that the characterizing property of the guide rail component model data record, which represents the length of the guide rail, has to be adapted when the digital replica data record is created, while the cross-sectional shape may already have been sufficiently defined by the default values.

The information taken from the manufacturer's information is also often sufficient for characterizing properties that reflect the material-specific properties of a component, such as its modulus of elasticity, its impact strength, and the like.

Target values in the sense of the present disclosure are values that define the characterizing properties of a component model data record in a target configuration. Such target values are usually defined by customer-specific configuration data in a modernized elevator installation or can be calculated on the basis thereof.

Customer-specific configuration data can be understood to mean specifications which are specified individually by the customer, for example when ordering the elevator installation. The customer-specific configuration data typically relate to a single elevator installation to be manufactured. For example, the customer-specific configuration data can comprise prevailing spatial conditions at the installation location, interface information for attachment to supporting structures of a building, etc.

In other words, the customer-specific configuration data can, for example, indicate how many floor levels the elevator installation must connect, the floor heights, how the elevator installation is to be connected to supporting structures within the building, and the like. Customer-specific configuration data can also include customer wishes with regard to functionality, delivery capacity, optics, etc. The data of the three-dimensional digital replica data record can be present, for example, as a CAD data record, which, among other things, reproduces geometric dimensions and/or other characterizing properties of the components forming the elevator installation.

This can mean that, for example, in the case of the above-mentioned component model data record configured as a guide rail component model data record, its default value as the length-defining, characterizing property is replaced by a target value that is predetermined by the customer-specific configuration data. If necessary, the target value is also provided with a tolerance specification.

Actual values in the sense of the present disclosure are values that have been determined on the physical component, which is virtually represented by the component model data record, by measuring, checking, and testing.

The more characterizing properties of a component model data record are defined by an actual value, the more precise the overall simulation environment and the more precise the parameter set determined by testing and optimizing the elevator control unit in the simulation environment. For the aforementioned reasons, the component model data records of the three-dimensional digital replica data record serving as the simulation environment can be characterized in a mixed manner by default values, target values, and actual values.

According to the disclosure, in the case of an existing elevator installation that is to be modernized, at least some of its actual values are recorded by at least one measurement run, each floor level of the existing elevator system being approached at least once. At least those measurement data representing floor heights can be recorded by means of a measuring device. For each floor level of the existing elevator installation recorded by the measuring run, component model data records configured as a floor section component model data record and/or component model data records configured as a shaft section component model data record are therefore arranged in the recorded sequence one above the other in the vertical direction. In these cases, the default value of the characterizing property, which defines the height distance from the next component model data record, is replaced by the corresponding floor height determined from the measurement data.

The measuring device as outlined in the present application may comprise a large number of devices. For example, this can be a mobile phone with an acceleration sensor, which is placed on the cab floor and records the measurement data when traveling from floor level to floor level. It can also be a transmission unit that can be connected to the elevator control unit of the existing elevator installation, reads measurement data from the elevator control unit, prepares them, if necessary, in the intended manner and makes them available to the system described below. In addition to the above-described mobile telephone or the transmission unit, the measuring device may also be a plurality of devices that communicate with one another permanently or temporarily, such as a portable computer, a data logger, a laser scanner, an RFID tag reading device and the like, or may comprise them.

In other words, for each floor level of the elevator installation detected by the measuring run, a component model data record configured as a floor section component model data record, for example, may be arranged in the recorded sequence one above the other in the vertical direction and the default value of its characterizing property, which defines the height distance to the next floor section component model data record, is replaced by the corresponding actual value of the floor height determined from the measurement data.

The feature of arrangement one above the other in the vertical direction can mean that the component model data records are arranged in such a way that floor levels and shaft sections are virtually mapped in the three-dimensional digital replica data record, analogous to the existing or modernized elevator installation, wherein “vertical” generally describes the direction of transport.

In one embodiment of the disclosure, each floor section component model data record or each shaft section component model data record can have predefined interfaces, via which interfaces component model data records can be connected to one another and positioned relative to one another. Corresponding characterizing properties of each component model data record to be added are automatically replicated with the characterizing properties of the component model data record provided via the interface for the connection. “Replicate” here can mean a process that compares the characterizing properties of two interconnected component model data records to one another if they relate to the same characterizing properties. For example, shaft section component model data records are used which replicate the characterizing properties “depth” and “width” that define the shaft section cross section of the shaft cross section component model data records connected to each other via the interfaces, because an elevator shaft usually has the same shaft cross section over its entire height. Other characterizing properties, such as the material properties of the shaft walls, can also be replicated across all shaft section component model data records.

However, the floor heights can be very different and, for example, can be defined as non-replicable if they are not adjacent to one another and therefore not arranged in a corresponding manner. The replication instructions can be stored in a special rule set for each component model data record. In principle, these replication instructions can stipulate that, in the replication, characterizing properties defined by measured values have priority over characterizing properties defined by default values.

In a further embodiment of the disclosure, each floor section component model data record can have predefined interfaces and a component model data record configured as a shaft section component model data record can be connected to these interfaces. The dimensions of the shaft section component model data record are also characterized by default values, which logically do not correspond to the dimensions of the assigned existing or modernized elevator installation. In the connection, the default value of a characterizing property of the shaft section component model data record connected to its interfaces, which defines the height of the shaft section, is now replaced, and thus replicated, by the height distance of the floor section component model data record connected thereto.

In a further embodiment of the disclosure, each floor section component model data record can have predefined interfaces and a component model data record configured as a shaft component model data record can be connected to the interfaces of all floor section component model data records. The floor heights of all floor section component model data records can be added to a total height, and this total height can replace the default value of the corresponding characterizing property of the shaft component model data record connected to the interfaces in the sense of replicating corresponding characterizing properties.

In a further embodiment of the disclosure, a component model data record configured as an elevator cab component model data record can be arranged in the virtual shaft formed by at least one shaft section component model data record. Its characterizing properties include at least parameters that can be changed during the implementation of the method and are part of the parameter set to be determined. In other words, this is a component model data record that can be mapped in a movable manner and that can be moved in virtual three-dimensional space relative to other component model data records, such as the shaft section component model data records. Accordingly, such a dynamic characterizing property has a movement profile which comprises at least one movement direction vector which specifies the direction of movement of the assigned component model data record relative to static component model data records such as, for example, the shaft section component model data records. Furthermore, the motion profile can also have the entire range of motion over the distance to be covered, which is defined as a floor height or a plurality of floor heights. The motion profile represents the acceleration phase, the driving phase at constant speed and the deceleration phase.

Furthermore, a component model data record configured as a suspension device component model data record can also be arranged in the virtual shaft formed by at least one shaft section component model data record, the characterizing properties of which also include at least parameters that can be changed during the implementation of the method and are part of the parameter set to be determined. Specifically, the mass and the free-swinging length of the suspension device change depending on the position of the elevator cab in the shaft. In order to take these conditions into account in the simulation environment, they can also be assigned to the suspension device component model data record as dynamic characterizing properties.

In other words, in the case of an existing elevator installation, the individual motion profiles of the elevator cab recorded during the measurement run can be assigned to the elevator cab component model data record in the order of the floor levels as characterizing properties. This can mean that specific component model data records, which represent movable components of the existing elevator installation, can also have dynamic, characterizing properties and are therefore strictly characterized in four dimensions.

Furthermore, spatial dimensions of the existing elevator cab can be recorded as measured values and the default values of the assigned, characterizing properties of the elevator cab component model data record can be replaced by the measured spatial dimensions. Furthermore, the characterizing properties of the at least one elevator cab component model data record can be checked using a collision checking routine and, in the case of colliding dimensions, corresponding characterizing properties of the at least one shaft section component model data record can be adapted to the projections of the elevator cab component model data record leading to collisions.

In other words, the shaft cross section of at least the elevator cab component model data record is automatically expanded at least to the floor area of the elevator cab. In this case, the adaptation can be carried out by means of an adaptation routine which provides the usual distances to the cab walls for the shaft cross section and, if appropriate, also a cross section add-on for a counterweight component model data record.

The same naturally also applies to a modernized elevator installation, whereby the default values of the characterizing properties of the component model data records are not replaced by the transfer of measured values, but by the transfer and implementation of the customer-specific configuration data.

In summary, it can be said that the construction of a three-dimensional digital replica data record creates a digital three-dimensional image of the existing elevator installation, the substantial features of which correspond to the characterizing properties of the assigned elevator installation by means of the transfer and implementation of the measurement data or by means of the implementation of customer-specific configuration data. In this case, at least the number of floor levels with a corresponding number of floor section component model data records and/or shaft section component model data records is mapped on the basis of the recorded measurement data or the customer-specific configuration data and the floor spacing or floor height is adapted accordingly to the measurement data. Such a three-dimensional digital replica data record now offers the perfect basis for a simulation environment to program and test the new elevator control unit for an existing elevator installation or the elevator control unit for a modernized elevator installation. The more comprehensively and precisely the existing or modernized elevator installation is represented in the assigned three-dimensional digital replica data record, the better the simulation results, of course.

The three-dimensional digital replica data record created by the computer program product can now be used as a simulation environment for dynamic simulations. For example, in a further embodiment of the disclosure, the three-dimensional digital replica data record can be called up from a storage medium and can be shown on a screen as a virtual elevator installation, at least reproducing the floor heights of the floor levels in the correct relationship to one another and dynamically reproducing the parameter set of the elevator control unit on the component model data record of the elevator cab. This allows the movement sequences of the elevator cab in the elevator shaft to be displayed and visually assessed by the technician responsible for optimizing the control data. If necessary, the technician can make various adjustments to the parameter set and test their effects in the simulation environment.

The three-dimensional digital replica data record described above can be further refined, for example, in the case of an existing elevator installation, in that the recording technician enters the elevator installation, and measures for example the shaft pit, the shaft head and the cross section of the shaft and inputs the corresponding default values of component model data records affected by these measurement data via an input interface, which belongs to the system for optimizing control data of an elevator control unit described below. In some cases, as part of the measuring device, the technician may also have a laser distance measuring device which can communicate wirelessly with the input interface, so that the measurement values are adopted in a partially automated manner. Here, the technician can be guided, for example, by screen instructions on an output interface of the system, step by step through the measuring run and the recording of further characterizing properties of the existing elevator installation.

In a further embodiment of the disclosure, further component model data records of components of an elevator installation can be selected from a database via a graphical user interface (GUI) and inserted into the three-dimensional digital replica data record via predefined interfaces. The selection can be made in a partially automated manner by the technician, for example by the system proposing suitable components to him on the basis of the recorded characterizing properties and processed measured data. However, the selection can also be made by the technician reading in identifiers of installed components, such as, for example, serial numbers, barcodes, matrix codes, RFID tags and so forth, using a suitable reading device of the system. Due to the recorded identifiers, only components that match these identifiers appear on the graphical user interface.

In the case of an elevator installation that is to be modernized, the system can suggest suitable components based on the customer-specific configuration data processed based on characterizing properties that have been recorded.

The technician can then insert the proposed components at the right place, for example using “drag and drop” functions, in a three-dimensional virtual representation of the digital replica data record. However, there is also the possibility that images and image sequences recorded using a time-of-flight camera or a laser scanner can be processed by an image data processing program, components installed or to be installed in the elevator installation by this processing being identifiable and their corresponding component model data records being insertable directly in the three-dimensional digital replica data record or suggestable on the graphical user interface.

Counterweight, guide rail, shaft door, cab door, drive and suspension device component model data records in various suspension device guiding options, for example, are selected as component model data records of components.

In a further embodiment of the disclosure, the characterizing properties defined by measurement data or customer-specific configuration data can be provided with a label, so that they can be distinguished from characterizing properties with default values.

In a further embodiment of the disclosure, a component model data record of the digital replica data record can be replaced by a definitive component model data record by its characterizing properties provided with a designation being read via an exchange routine, based on these designated, characterizing properties from a database possible definitive component model data records of actually existing components of elevator installations can be determined, and the replacement component model data record can optionally additionally be selected by manual inputs. After selection of the appropriate, replacement component model data record, the corresponding component model data record of the digital replica data record is deleted and the replacement component model data record is inserted at the corresponding interfaces of the digital replica data record that the deleted component model data record has released.

The three-dimensional digital replica data record now provides a simulation environment by means of which various states of the existing or modernized elevator installation can be dynamically checked. This can mean that test results no longer simply have to be extrapolated from the test tower, but that the behavior of the parameter set implemented in the elevator control unit can be checked and optimized on the basis of the components or component model data records virtually available through the three-dimensional digital replica data record. The noise problem of an elevator installation mentioned above arises, for example, from a vibration system of elevator cab and suspension device, the complex relationships of which are explained in a rudimentary manner below.

The suspension device has certain elastic properties in the longitudinal and transverse directions, a certain area moment of inertia given by its cross section, and a certain dead weight for a certain length. All of these features are preferably also stored in the suspension device model data record of the digital replica data record as characterizing properties. As already mentioned above, the height of the elevator shaft and the individual floor heights are also shown as precisely as possible in the digital double data set. The empty weight of the elevator cab and its maximum possible payload can also be assigned to the elevator cab component model data record as characterizing properties.

Excited by the movement in the elevator shaft (for example, due to the frictional relationships stored as characterizing properties between a guide shoe of the elevator cab and a guide rail), the natural frequency of this vibration system can be reached with a certain length of suspension device and the vibrations of the suspension device transverse to its longitudinal extent can resonate. Using the modern, available simulation methods, which include, for example, finite element analyzes, a variety of different scenarios (different loading of the elevator cab, different speed profiles, additional external influences defined by characterizing properties such as temperature, humidity, air pressure, and the like) can be calculated and simulated as an optimization routine for each shaft section, so that ideal speed profiles can be determined for each of these shaft sections and for travels that extend over a plurality of floor levels, which can be stored as parameters in the elevator control unit. In other words, the parameter set is determined in the simulation environment using an optimization routine according to specifiable quality criteria. The specified quality criteria are, for example, tolerance specifications with regard to the maximum permissible vibration amplitudes of the suspension device and accelerations and decelerations of the elevator cab that are pleasant for the user of the elevator installation with the shortest possible duration of the travel.

The more precisely the three-dimensional digital replica data record maps the existing or modernized elevator installation, the more precisely an optimized parameter set can be determined for the elevator control unit thereof. This optimized parameter set can then be adopted in the elevator control unit of the physical elevator installation and it can be assumed that this already delivers perfect results with regard to its operating behavior when the elevator installation is started up.

As has already been mentioned multiple times above, a system for optimizing control data of an elevator control unit with regard to an associated existing or modernized elevator installation is provided, with which the previously described method can be carried out. The system furthermore includes a programmable device and a computer program product with machine-readable program instructions. Here, the programmable device can be a single device such as a personal computer, a laptop, a mobile phone, a tablet, an elevator control unit of an elevator installation, or the like. However, the programmable device may also comprise one or more computers. In particular, the programmable device can be formed from a computer network which processes data via cloud computing. For this purpose, the programmable device can have a memory in which the data of the three-dimensional digital replica data record and the component model data records of various configurations required for its creation can be stored, for example in electronic or magnetic form. The programmable device may also have data processing options. For example, the programmable device may have a processor, by means of which data from all of these data records and the machine-readable program instructions of the computer program product can be processed. The programmable device may also have data interfaces via which data can be input into the programmable device and/or output from the programmable device. The programmable device may also be implemented in a spatially distributed manner, for example when data are processed in a data cloud distributed over a plurality of computers.

In particular, the programmable device may be programmable, that is, it may be prompted by a suitably programmed computer program product to execute or control computer-processable steps and data of the methods according to the disclosure. The computer program product may contain instructions or code which, for example, cause the processor of the device to create, store, read, process, modify, etc. the data of the three-dimensional digital replica data record, etc. The computer program product may be written in any computer language.

By executing the computer program product on the programmable device or by means of previously recorded customer-specific configuration data recorded by the measuring device, a three-dimensional digital replica data record can be assembled from component model data records and stored in a storage medium of the programmable device while taking into account the measurement data. The component model data records that can be called up for this purpose from a database have different configurations and are defined by characterizing properties that are predefined with default values. The database having the component model data records is preferably also stored in the data cloud, but it can also be part of the computer program product.

In the case of an existing elevator installation, the system can also have at least one measuring device, by means of which at least those measurement data from which floor heights of the floors of the elevator installation can be recorded are determinable via at least one measuring run with an existing elevator installation. This includes, for example, the movement profile and the travel time between the floors from which the floor heights can be calculated. Of course, the floor heights can also be determined from data of the elevator control unit of the existing elevator installation, for example from a shaft information system connected to the elevator control unit, from sensor signals generated by sensors of the existing elevator installation that are connected to the elevator control unit, and so forth. The measuring device can be a device specially configured for this purpose which is equipped with data storage resources such as RAM, ROM, EPROM, hard disk memory, SDRAM and so forth, data processing resources such as processors, processor networks, and so forth, interfaces such as an input interface and an output interface, and device interfaces, which allow communication with other devices such as, for example, with the elevator control unit of the existing elevator installation, with the programmable device of the system described below and so forth, as well as sensors. However, the measuring device can also be a conglomerate of different, physically separate devices which have the properties and resources described above as a whole and can exchange data with one another.

In order to facilitate the recording of the relevant parameters, the measuring device may also be connected to the elevator control unit of the existing elevator installation. As a result, the measuring device is able to extract characterizing properties from the elevator control unit and to transmit them to the programmable device of the system.

In summary, it can be said that the computer program product comprises machine-readable program instructions which, when executed on a programmable device, cause the device to carry out or control the above-described embodiments of the method according to the disclosure.

The computer program product may be stored on any computer readable medium, for example a flash memory, a CD, a DVD, RAM, ROM, PROM, EPROM, a floppy disk, and so forth. The computer program product and/or the data to be processed with it may also be stored on a server or a plurality of servers, for example in a data cloud, from whence they can be downloaded via a network, for example the Internet.

It should be noted that some of the possible features and advantages of the disclosure are described herein with reference to different embodiments. A person skilled in the art recognizes that the features can be combined, transferred, adapted, or replaced in a suitable manner in order to arrive at further embodiments of the disclosure.

### BRIEF DESCRIPTION OF THE DRAWINGS

Embodiments of the disclosure will be described in the following with reference to the accompanying drawings, although neither the drawings nor the description should be construed as limiting the disclosure.

FIG. 1 shows schematically in three-dimensional view, an existing or modernized elevator installation, the elevator shaft being shown only schematically for the sake of clarity and the floors to be connected to the elevator installation only being indicated with a broken line;

FIGS. 2A to 2D show schematically example method steps for creating a three-dimensional digital replica data record of a modernized elevator installation or the existing elevator installation shown in FIG. 1;

FIG. 3 shows schematically in three-dimensional view the substantial components of a system that is suitable for performing the method shown in FIGS. 2A to 2D; and

FIG. 4 shows schematically different speed profiles of a particular floor section, the optimal parameter set of the elevator control unit for this floor section being determined in the simulation environment of the three-dimensional digital replica data record by means of an optimization routine according to specifiable quality criteria.

### DETAILED DESCRIPTION

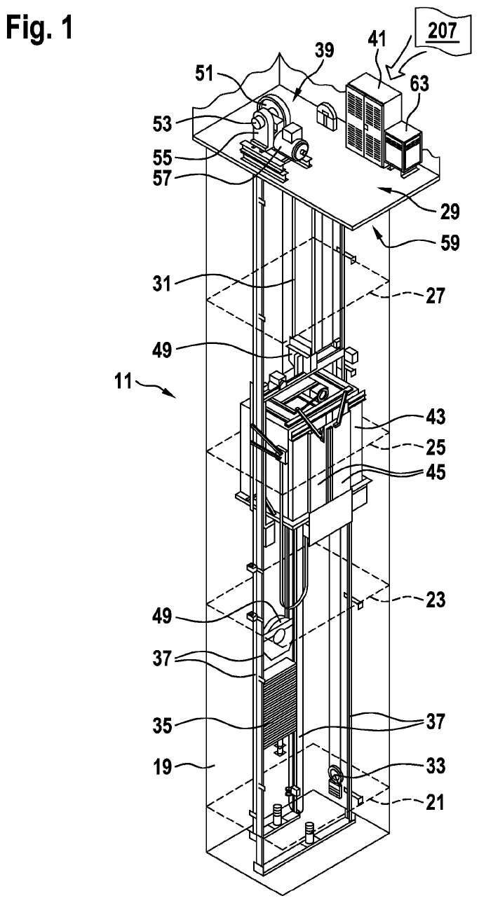

FIG. 1 shows schematically a three-dimensional view of an existing or modernized elevator installation 11, the elevator shaft 19 of which being only shown schematically for the sake of clarity and the floors 21, 23, 25, 27 created on site to be connected to the elevator installation 11 being only indicated with a broken line.

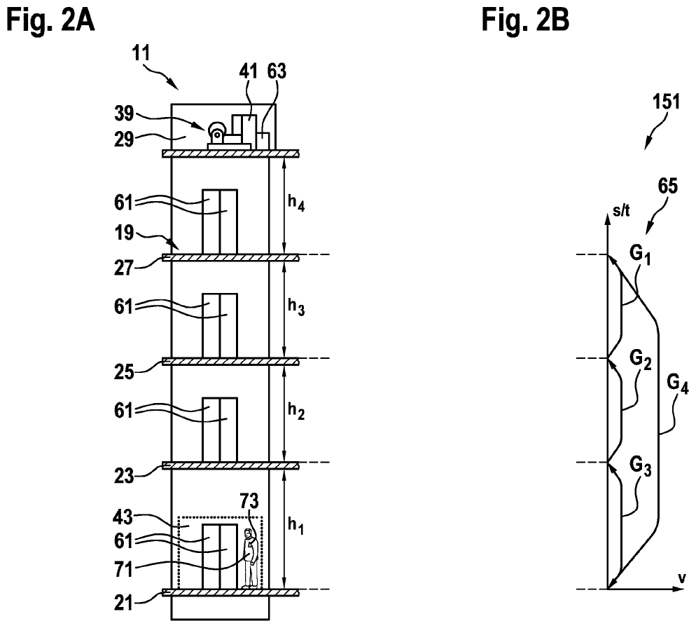

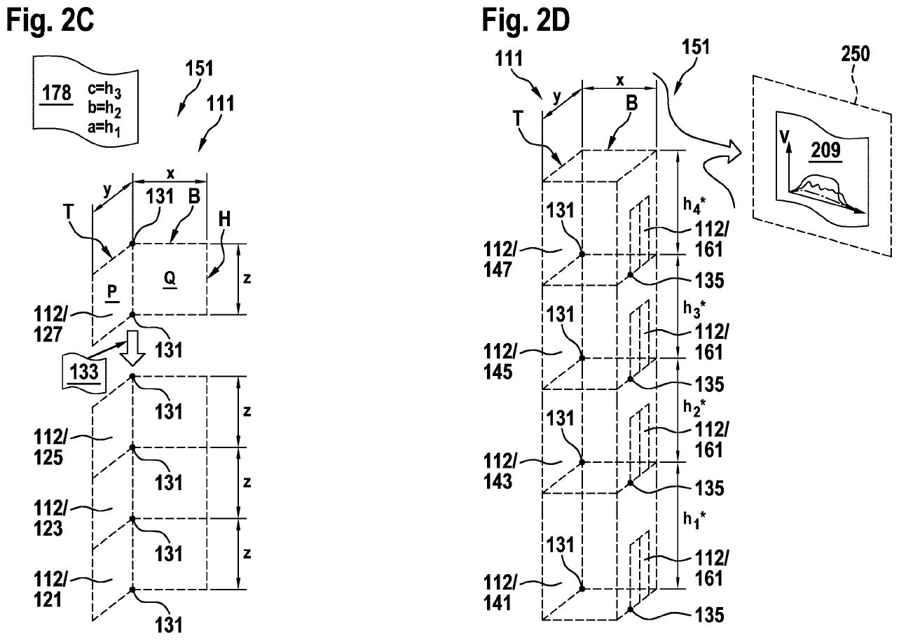

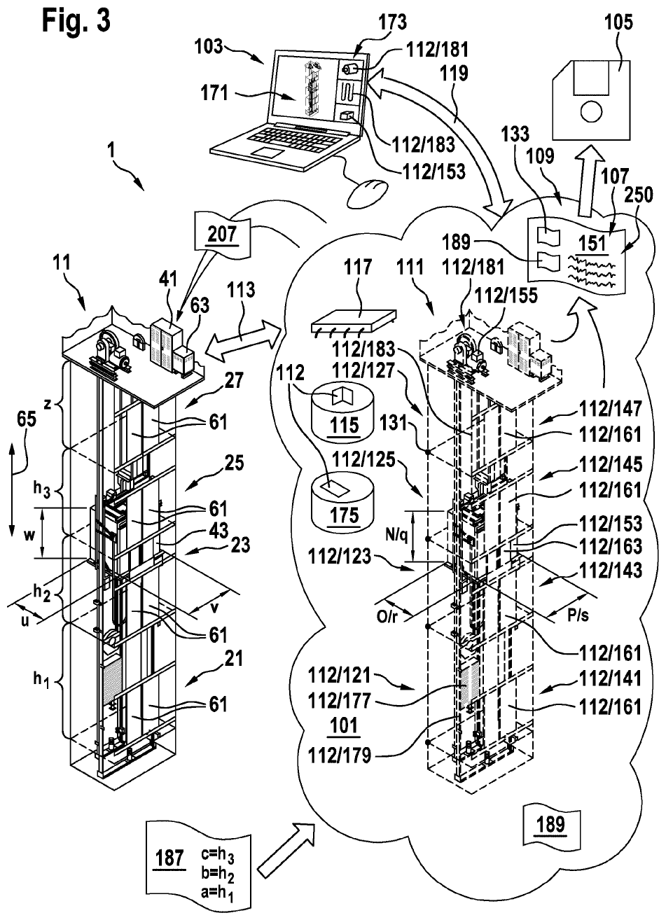

The elevator installation 11 comprises many different components which are arranged in the elevator shaft 19 which is usually created on site. These also include all the components listed in this paragraph, such as guide rails 37 mounted on the walls of the elevator shaft 19, an elevator cab 43 guided on the guide rails 37 and a counterweight 35 guided on the guide rails 37. The counterweight 35 is connected to the elevator cab 43 in a load-bearing manner by a suspension device 31, for example a steel cable or a belt. In the present exemplary embodiment, the suspension device 31 is guided in a so-called 2:1 suspension arrangement over deflection rollers 49 and a traction sheave 51. Of course, other suspension device guiding options such as 1:1, 3:1 and so forth are also possible. The traction sheave 51 is driven by a drive unit 39, which usually comprises a service brake 53, a reduction gear 55 and a drive motor 57. The drive motor 57 is driven by an elevator control unit 41. In the present exemplary embodiment, the drive unit 39 and the elevator control unit 41 are arranged in a machine room 29 which is located exactly above the shaft head 59 of the elevator shaft 19. The elevator cab 43 has cab doors 45 which can be temporarily coupled to shaft doors 61 (see FIGS. 2A and 3) arranged on the floors 21, 23, 25, 27. There are also safety devices 33 that monitor the correct functioning of the existing elevator installation.

Depending on the design of the elevator installation 11, noise problems or vibration problems can occur if the parameter set 207 of the elevator control unit 41 is not optimally configured for the configuration of the elevator installation 11. Such noise problems are significantly caused by the interaction of the elastic and geometric properties of the suspension device 31, by the load or force acting on the suspension device 31 from the elevator cab 43 and by a speed profile of the elevator cab 43, which is specified by the parameter set 207 of the elevator control unit 41. The geometric properties also include the length of the suspension device, the decisive factor being not the total length of the suspension device 31, but rather its partial sections, which in the exemplary embodiment shown extend between the deflection rollers 49.

Based on FIGS. 2A to 2D, possible method steps of the method 151 according to the disclosure for optimizing control data of an existing or modernized elevator installation 11 and an associated creation of a three-dimensional digital replica data record 111 of the existing or modernized elevator installation 11 shown in FIG. 1 are explained below. FIG. 2A again shows the existing or modernized elevator installation 11 in a simplified manner, only the outer contours of the elevator shaft 19, the floors of floor levels 21, 23, 25, 27, the elevator cab 43 and the shaft doors 61 and the machine room 29 being shown.

According to a possible embodiment of the disclosure, as shown in FIG. 2B, at least one measuring run 65 with the elevator cab 43 of the existing elevator installation 11 is used to approach each floor level 21, 23, 25, 27 of the elevator installation 11 at least once, and at least those measurement data G1, G2, G3, G4, h1, h2, h3 which represent floor heights h1, h2, h3 are recorded by means of a measuring device 63. In the present exemplary embodiment, the measuring device 63 is a data recording device which receives the measurement data G1, G2, G3, G4, h1, h2, h3 from the elevator control unit 41 or extracts them from control signals and sensor data transmitted to the elevator control unit 41 from sensors installed in the elevator installation 11 and stores them, or can forward these measurement data G1, G2, G3, G4, h1, h2, h3. For this purpose, the measuring device 63 can have a suitable computer program, which acts on the elevator control unit 41 of the existing elevator installation 11 and initiates the required measuring run 65. In this case, for example, the floor heights h1, h2, h3 can be read out directly from the control signals of the elevator control unit 41 as measurement data h1, h2, h3 which are transmitted, for example, from a shaft information system (not shown) of the existing elevator installation 11 to the elevator control unit 41. Furthermore, the motion profiles can be recorded as measurement data G1, G2, G3, G4. Since these represent the speed V of the elevator cab 43 over time t, the floor heights h1, h2, h3 can of course also be calculated from these measurement data G1, G2, G3, G4.

Of course, the measuring run 65 may also be carried out without measurement data G1, G2, G3, G4, h1, h2, h3 being read out from the elevator control unit 41 of the existing elevator installation 11. For this purpose, for example, a technician 71 can enter the elevator cab 43 with his mobile phone (smartphone) and carry out the measuring run 65 with the existing elevator installation 11. The mobile phone as the measuring device 73 records the acceleration and deceleration profile and the travel time from floor level to floor level or the motion profiles as measurement data G1, G2, G3, G4. He preferably places the mobile phone or the measuring device 73 on the floor of the elevator cab 43 during the measuring run 65 in order not to falsify the measurement data G1, G2, G3, G4. The floor heights h1, h2, h3 of the individual floor levels 21, 23, 25, 27 can in turn be calculated from these measurement data G1, G2, G3, G4.

According to a further possible embodiment of the disclosure, a three-dimensional digital replica data record 111 can also be created on the basis of a modernized elevator installation 11. In this case, the customer-specific configuration data 178 required for planning are used, which have been created by the customer or in cooperation with the customer. Logically, the number of floor levels 21, 23, 25, 27 and their floor heights h1, h2, h3 do not have to be determined by means of a measuring run 65, but can be found directly in the customer-specific configuration data 178.

As shown in FIG. 2C, taking into account these measurement data G1, G2, G3, G4, h1, h2, h3 or the customer-specific configuration data 178, a three-dimensional digital replica data record 111 can be assembled step by step from component model data records 112 and stored in a storage medium 101 (see FIG. 3). The component model data records 112 can have different configurations and are defined by characterizing properties B, T, H, wherein each characterizing property is predefined by a default value x, y, z, by a target value a, b, c, or is determined by an actual value q, r, s (see FIG. 3).

The characterizing properties B, T, H that define the nature of the component model data records 112 can be, for example, geometric dimensions of the components they represent, weights of the components they represent, material properties of the components they represent, and/or surface properties of the components they represent. Of course, dynamic information, such as the motion profiles already mentioned, can also be assigned to a component model data record 112 as characterizing properties and characterize its dynamic behavior. In other words, a plurality of characterizing properties B, T, H of one component or of a plurality of components of the elevator installation 11 can be determined and stored as measurement data G2, G3, G4, h1, h2, h3 or data a, b, c derived from customer-specific configuration data 187 in the three-dimensional digital replica data record 111. Geometric dimensions of the components can be, for example, a length, a width, a height, a depth, a cross section, radii, fillets, etc. of the components. Material properties of the components can be, for example, a type of material used to form a component or a partial area of a component. Furthermore, material properties can also be strength properties, hardness properties, electrical properties, magnetic properties, optical properties, elastic properties, etc. of the components. Surface properties of the components can be, for example, roughness, textures, coatings, colors, reflectivities, etc. of the components. The characterizing properties B, T, H can refer to individual components or component groups. For example, the characterizing properties B, T, H can relate to individual components from which larger, more complex component groups are composed. As an alternative or in addition, the characterizing properties B, T, H may also refer to more complex equipment composed of a plurality of components, such as drive motors, gear units, suspension device, etc.

In order to assemble the three-dimensional digital replica data record 111, in each case a component model data record 112 configured as a floor section component model data record 121, 123, 125, 127 can be arranged in the recorded sequence, or the sequence resulting from the customer-specific configuration data 187, one above the other in the vertical direction for each floor level 21, 23, 25, 27 of the elevator installation 11, wherein for this purpose interface information 131 which is correctly arranged and consolidated is preferably defined on the floor section component model data record 121, 123, 125, 127, for example, with the aid of a rule set 133. As already mentioned, component model data records 112 are defined by characterizing properties B, T, H, and these characterizing properties B, T, H are in turn predefined by default values x, y, z. In the present exemplary embodiment in FIG. 2C, the floor section component model data records 121, 123, 125, 127 are defined by two surfaces P and Q arranged at right angles to one another, the planar dimensions of which are each predefined by the characterizing properties width B, depth T, and height H with a corresponding default value x, y, z. Accordingly, this three-dimensional digital replica data record 111 or the virtual model thus created, which can be represented in three dimensions, initially only correctly displays the number of floor levels 21, 23, 25, 27 of the elevator installation 11.

As FIG. 2D shows, the three-dimensional digital replica data record 111 or this virtual model which can be represented three-dimensionally is now gradually refined and specified by the default value z of the characterizing property height H of each floor section component model data record 121, 123, 125, 127 which defines the height distance to the next floor section component model data record being replaced by the corresponding floor heights h1, h2, h3 determined from the measurement data G1, G2, G3, G4, h1, h2, h3 or customer-specific configuration data 187. On the basis of the floor heights h1, h2, h3 shown in FIG. 2D, it is evident that they differ significantly from the default values x, y, z of FIG. 2C and also from one another.

It can also be seen that the floor height h4 of the top floor level 27 of an existing elevator installation 11 cannot be calculated or defined by the measurement data G1, G2, G3, G4, h1, h2, h3 determined by means of a measuring run 65. For example, the technician must measure this floor height h4 manually and record it as measurement data h4 or its default value z is initially maintained until further measurement data on this characterizing property height H of the top floor level 27 are available. In modernized elevator installations, the target value for this floor height h4 can be determined from the customer-specific configuration data 187. Those characterizing properties B, T, H whose default values x, y, z have been replaced by measurement data G1, G2, G3, G4, h1, h2, h3 or target values h4 can be provided with a designation, as shown symbolically in the present exemplary embodiment with an asterisk as h1*, h2*, h3*, h4*. Such a designation * can be a code portion, a prefix, a suffix, and the like.

As discussed previously, each floor section component model data record 121, 123, 125, 127 has predefined interfaces 131. These serve not only as reciprocal positioning points when the floor section component model data records 121, 123, 125, 127 are combined, but also as interfaces 131 when additional component model data records 112 are added. As shown in FIG. 2D, a component model data record 112 configured as a shaft section component model data record 141, 143, 145, 147 can now also be added to these interfaces 131. The default value x, y, z of a characterizing property B, T, H of the shaft section component model data record 141, 143, 145, 147 connected to its interfaces 131 and which defines the shaft section height, is replaced or replicated by the corresponding floor height h1, h2, h3, h4 of the floor section component model data record 121, 123, 125, 127.

Of course, there is also the possibility of directly using, instead of the floor section component model data records 121, 123, 125, 127 described above, a shaft component model data record or a plurality of shaft component model data records 141, 143, 145, 147 as a component model data record 112. These preferably also have the characterizing properties B, T, H in the sense of the floor section component model data records 121, 123, 125, 127 and the interfaces 131 in order to be able to correctly create the three-dimensional digital replica data record 111 and to correctly reflect at least the number of floor levels and the floor heights h1, h2, h3, z.

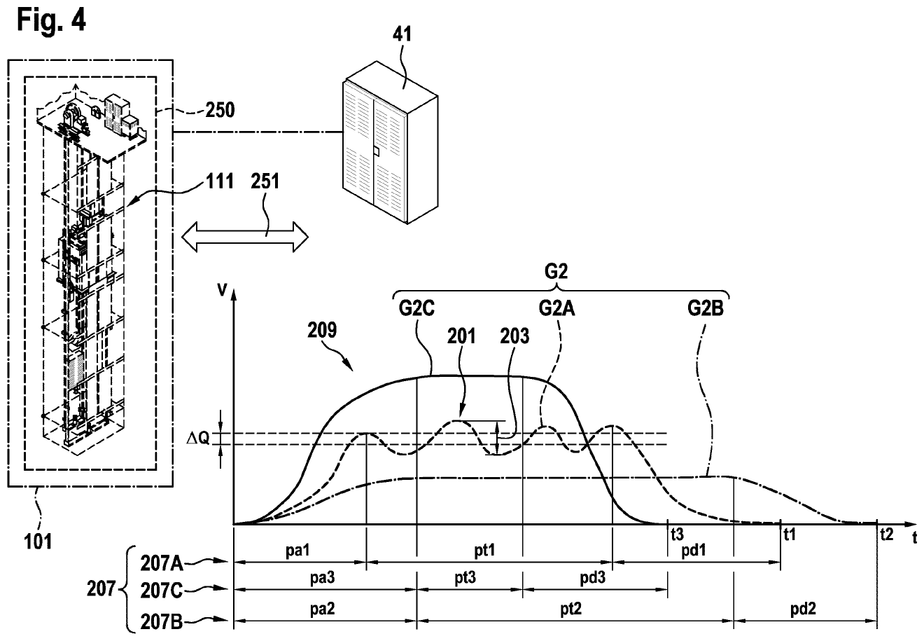

In principle, each component model data record 112, depending on its configuration, can have a plurality of interfaces 131, 135 for adding further component model data records 112. For example, the shaft section component model data records 141, 143, 145, 147 can have—in addition to the interfaces 131 matching the floor section component model data records 141, 143, 145, 147 and/or each other—also interfaces 135 for shaft door component model data records 161. Information about which component model data records 112 are arranged at which interfaces 131, 135 of other component model data records 112 can be stored in the rule set 133 of the computer program product 109 described below. Like a higher-level parts list and building instructions, this rule set 133 defines the structure of the three-dimensional digital replica data record 111. As indicated in FIG. 2D, a sufficiently defined, created three-dimensional digital replica data record 111 can now be used as a simulation environment 250 for optimizing control data, for example using the optimization routine 209 described in more detail in FIG. 4.

The simulation environment 250 is substantially formed by the three-dimensional digital replica data record 111. However, additional data records may be required in order to bring the three-dimensional digital replica data record 111 into a so-called “executable state” so that it can be used as a simulation environment 250 for static and dynamic simulations. Such additional data records can be storage instructions, imaging instructions, simulation instructions, communication instructions with output and input units, compilation instructions, interface protocols, and the like. These data records can also be part of the computer program product 109 and can implement at least partial steps of the method 151 according to the disclosure.

FIG. 3 schematically shows in a three-dimensional view the substantial components of a system 1 which is suitable for carrying out the method 151 shown in FIGS. 2A to 2D. This system 1 for optimizing control data of an elevator control unit 41 with regard to an assigned existing or modernized elevator installation 11 can substantially have the following system parts:
a programmable device 101; and
a computer program product 109 with machine-readable program instructions 107.

In addition, the system 1 can have at least one measuring device 63, by means of which at least one measuring run 65 with the existing elevator installation 11 can be used to record at least those measurement data h1, h2, h3 from which floor heights h1, h2, h3 of the floor levels 21, 23, 25, 27 of the elevator installation 11 can be determined.

As already mentioned in the description of FIG. 2, the measuring device 63 of the depicted exemplary embodiment accesses measurement data G1, G2, G3, G4, h1, h2, h3 of the elevator control unit 41 of the existing elevator installation 11 and transmits it, symbolically represented by the double arrow 113, to the programmable device 101.

The programmable device 101 can be a single device such as, for example, a personal computer, a laptop, a mobile phone, a tablet, the elevator control unit 41 of the existing elevator installation 11, or the like. However, the programmable device 101 can also comprise one or more computers. In particular, the programmable device 101, as shown in FIG. 3, can be formed from a computer network which processes data in the form of a data cloud. For this purpose, the programmable device 101 can have a storage medium 115 in which the data of the digital replica data record 111 and the component model data records 112 of various configurations required for its creation can be stored, for example, in electronic or magnetic form. The programmable device 101 can also have data processing options. For example, the programmable device 101 can have a processor 117, with the aid of which data all of these component model data records 112 and the machine-readable program instructions 107 of the computer program product 109, in particular also program instructions for optimizing the control data or for generating a parameter set 207 having parameters pa, pt, pd and being matched to the three-dimensional digital replica data record 111 (see FIG. 4) can be processed. The optimized parameter set 207 can subsequently be implemented in the elevator control unit 63.

The programmable device 101 can also have the device interfaces symbolically represented by the double arrow 119, via which data can be input into the programmable device 101 and/or output from the programmable device 101. The programmable device 101 can also be implemented in a spatially distributed manner, for example when data is processed in a data cloud distributed over a plurality of computers.

In particular, the programmable device 101 can be programmable, that is, it can be prompted by a suitably programmed computer program product 109 to execute or control computer-processable steps and data of the method 151 according to the disclosure. The computer program product 109 can contain instructions or code which, for example, cause the processor 117 of the programmable device 101 to create, store, read out, process, modify data of a three-dimensional digital replica data record 111, set up a simulation environment 250 on the basis of the three-dimensional digital replica data record 111, carry out optimization routines 209 etc. In particular, the computer program product 109 can be written in any computer language.

The machine-readable program instructions 107 of the computer program product 109 reproduce in particular also the method steps of the method 151 according to the disclosure, shown by way of example in FIGS. 2A to 2D, in a machine-processable manner. Furthermore, the machine-readable program instructions 107 may have a large number of other program routines, such as various conversion routines for determining a floor height h1, h2, h3 from a motion profile G1, G2, G3, G4 (see FIG. 2B), control routines for controlling the interactions between the elevator control unit 41 and the measuring device 63, assignment routines which check the arrangement of component model data records 112 for their compatibility, rule sets 133 (see also FIG. 2C), collision check routines which check static and dynamic characterizing properties of the component model data records 112 arranged in the three-dimensional space with respect to one another, transmission protocols, control routines for the device interfaces, instruction routines for the technician, and the like.

By executing the computer program product 109 on the programmable device 101, taking into account the measurement data recorded by the measuring device 63, a three-dimensional digital replica data record 111 can be assembled from component model data records 112 and stored in the storage medium 115 of the programmable device 101. Here, the component model data records 112 can have different configurations and be configured, for example, as a floor section component model data record 121, 123, 125, 127, shaft section component model data record 141, 143, 145, 147, elevator cab component model data record 153, cab door component model data record 163, shaft door component model data record 161, drive component model data record 155 and so forth and can be defined by characterizing properties N, O, P, which are predefined with default values q, r, s.

For each floor level 21, 23, 25, 27 of an existing elevator installation 11 detected by the measuring run 65, in each case a component model data record 112 configured as a floor section component model data record 121, 123, 125, 127 is arranged one above the other in the vertical direction in the recorded sequence in the three-dimensional digital replica data record 111 created by the programmable device 101. In a modernized elevator installation 11, the customer-specific configuration data 187 are used for this. As shown in FIGS. 2A to 2D, the default value z of its characterizing property H, which defines the height distance to the next floor section component model data record, is replaced in each case by the corresponding floor height h1, h2, h3 determined from the measurement data G1, G2, G3, G4, h1, h2, h3.

Furthermore, a component model data record configured as an elevator cab component model data record 153 can be arranged in the virtual shaft formed by at least one shaft component model data record 141, 143, 145, 147. The individual motion profiles or parameters pa, pt, pd calculated by the simulation can also be assigned to the elevator cab component model data record 153 in the order of the floor component model data records 121, 123, 125, 127 as characterizing properties. This can mean that dynamic properties relative to the shaft component model data records 141, 143, 145, 147 are assigned to the elevator cab component model data record 153, so that the three-dimensional digital replica data record 111 with partially dynamic or movable component model data records 112 can be displayed on a screen 171, for example.

In other words, the three-dimensional digital replica data record 111 can be called up from the storage medium 115 and, as a virtual elevator installation, at least the floor heights between the floor levels can be displayed statically and/or dynamically on a screen 171 in a correct ratio. Due to the dynamic properties, the virtual elevator cab displayed on the screen 171 by the elevator cab component model data record 153 can also execute the same movements with the same directions of movement, accelerations, speeds and decelerations as the elevator cab 43 of the existing or modernized elevator installation 11 within the virtual elevator shaft formed by the shaft component model data records 141, 143, 145, 147.

Furthermore, spatial dimensions of the elevator cab 43 measured by the technician or extracted from plans and CAD files can be recorded as measured values u, v, w, and the default values q, r, s of the assigned, characterizing properties N, O, P of the elevator cab component model data record 153 can be replaced by the measured spatial dimensions, the default values x, y, z of the characterizing properties T, B, H of the shaft section component model data records 141, 143, 145, 147 or of the shaft component model data record being checked and, in the case of colliding dimensions, corresponding characterizing properties T, B, H being adapted to the projections of the characterizing properties N, O, P of the elevator cab component model data record 153 which lead to collisions. In particular, the cross section of the shaft section component model data records 141, 143, 145, 147, which is still defined by default values x, y, can be too small for the actual dimensions of the elevator cab 43. If necessary, a required play between the cab walls and the shaft walls can be added to the cab dimensions as standard in order to determine the characterizing properties T, B of the shaft section component model data records 141, 143, 145, 147 that characterize the shaft cross section, starting from the elevator cab 43.

In order to further simplify the creation of the three-dimensional digital replica data record 111, further component model data records 112 of components of an elevator installation can be selected from a database 175 via a graphical user interface 173 of an input interface/output interface 103 such as the illustrated laptop and inserted into the three-dimensional digital replica data record 111 via predefined interfaces 131, 135. Components of existing elevator installations 11 depicted in the database 175 as component model data records 112—such as various counterweight component model data records 177, guide rail component model data records 179, shaft door component model data records 161, cab door component model data records 163, drive component model data records 181 and suspension device component model data records 183 in various suspension device guiding options—can be available for selection.

The component model data records of actually existing components that can be called up from the database 175 can have completely determined characterizing properties N, O, P having actual values based on measurement results. To further improve the digital replica data record 111, its component model data records 112, which have mixed characterizing properties N, O, P determined with actual values u, v, w and pre-determined with the default values q, r, s, can be replaced by a definitive component model data record 181, 183, 153 from the database 175 with determined characterizing properties N, O, P. This can be done automatically by the characterizing properties N, O, P provided with a designation * being read out by an exchange routine 189 and, on the basis of these labeled, characterizing properties from the database 175, possible definitive component model data records 181, 183, 153 of actually existing components of elevator installations 11 that match the characterizing properties N, O, P are determined. Subsequently, the replacement component model data record 112 can, where appropriate, be additionally selected from these proposed definitive component model data records 181, 183, 153 by manual inputs. After selection, the replacement routine 189 can automatically delete the component model data record 112 to be exchanged and insert the replacement component model data record 112. In some cases, there are also identifying marks on components of the existing elevator installation 11, such as barcodes, matrix codes, RFID tags and the like, which allow a clear selection and use of the component model data record 112 representing this component by suitable detection in the system 1.

The computer program product 109 may be or may have been stored on any computer-readable medium 105.

By means of FIG. 4, by means of various speed profiles G2A, G2B, G2C of a certain floor section of the existing or modernized elevator installation 11 (see FIGS. 1 to 3) it shall be explained below how the optimal parameter set 207 for this floor section in the building can be determined by an optimization routine 209 according to specifiable quality criteria ΔQ in the simulation environment 250 using the three-dimensional digital replica data record 111. The double arrow 251 symbolizes the interaction between the optimization routine 209 and the simulation environment 250.

Strictly speaking, only one parameter set 207 is required to generate an optimal speed profile G2 for this shaft section. However, in order to be able to better explain the different stages of parameter set 207, the reference numerals of the related features “speed profile G2” and “parameter set 207” were added alphanumerically.

As already described in detail, the three-dimensional digital replica data record 111 of the existing or modernized elevator installation 11 now provides a simulation environment 250, by means of which various states of the existing or modernized elevator installation 11 can be checked dynamically. This can mean that test results no longer simply have to be extrapolated from the test tower, but that the behavior of the parameter set 207 implemented in the elevator control unit 41 can be checked and optimized by means of the interactions of the components or component model data records 112 virtually available by means of the three-dimensional digital replica data record 111.

In order for the optimization routine 209 to be carried out, the elevator control unit 41 of the modernized or existing elevator installation 11 must be physically present and, as shown by the dash-and-dot line, connected to the programmable device 101. The simulation environment 250 is executable on the programmable device 101, which is also indicated by a dash-and-dot line, which in turn is based on the three-dimensional digital replica data record 111 that depicts the system.

The noise problem of an elevator installation 11 mentioned above arises, for example, from a vibration system of elevator cab 43 and suspension device 31, the complex relationships of which are explained in a rudimentary manner below.

The suspension device 31 has certain elastic properties in the longitudinal and transverse directions, a certain area moment of inertia given by its cross section and a length-dependent net weight. All of these features are also stored in the suspension device component model data record 183 of the digital replica data record 111 as characterizing properties. As already mentioned above, the height of the elevator shaft 27 and the individual floor heights h1, h2, h3, h4 are also shown as precisely as possible in the digital replica data record. The empty weight of the elevator cab 43 and its maximum possible payload can also be assigned to the elevator cab component model data record 153 as characterizing properties.

Excited by the travel in the elevator shaft 27 or in the elevator shaft component model data record 127 (for example, by means of frictional relationships stored as characterizing properties, between a guide shoe component model data record, not shown, which is connected via interfaces to the elevator cab component model data record 153 and a guide rail component model data record 179), the natural frequency of this vibration system can be reached with a certain suspension device length, so that the vibrations of the suspension device 31 resonate transversely to the longitudinal extent thereof. Using the modern, available simulation methods, which include, for example, finite element analyzes, a variety of different scenarios (different loading of the elevator cab, different speed profiles G2A, G2B, G2C, additional external influences defined by characterizing properties such as temperature, humidity, air pressure, and the like) can be dynamically calculated and simulated as an optimization routine 209 for each shaft section, so that ideal speed profiles G2A, G2B, G2C can be determined for each of these shaft sections and for travels that extend over a plurality of floor levels 21, 23, 25, 27, which can be stored as parameter sets 207 in the elevator control unit 41 and can be used by the latter.

Optimization routines 209 are preferably programmed such that a simulation is carried out in the simulation environment 250 with a parameter set 207, then the simulation results are evaluated using various analysis methods (stochastic methods, algorithms, fuzzy logic, etc.), including previous simulation results, and on the basis of these analysis results of the parameter set 207 is changed in order to test this in turn in the simulation environment 250. These so-called optimization or test loops are continued until the simulation results meet the specifiable quality criteria ΔQ.

In the present exemplary embodiment in FIG. 4, three speed profiles G2A, G2B, G2C of the elevator cab 43, or of their dynamically movable elevator cab component model data record 153, are shown between two specific floor levels and thus for a specific shaft section. The first speed profile G2A, shown with a broken line, shows the travel of the elevator cab 43, 153 with the parameter set 207A stored in the elevator control unit 41 as the basic setting. This defines an acceleration phase pa1, a driving phase pt1 without substantial acceleration or deceleration, and a deceleration phase pd1. In the dynamic simulation of a travel in the simulation environment 250 of the previously created digital replica data record 111, vibrations 201 occur with this parameter set 207A, the amplitudes 203 of which exceed the limit band defined as quality criterion ΔQ. The consequences of these vibrations are noise problems in the elevator cab 43.

These problems could be remedied, for example, by a changed parameter set 207B with a changed acceleration phase pa2 and with a driving phase pt2 at a lower speed V. Such a parameter set 207B having the acceleration phase pa2, the driving phase pt2 and the deceleration phase pd2, which produces the speed profile G2B represented by a dash-dotted line, would be set by a technician on site after numerous tests on the elevator installation 11 in order to eliminate the noise problems. However, as the graphic shows by means of the two travel time ends t1, t2, the travel time between the two floor levels would be significantly longer and thereby the elevator installation 11 would be noticeably slower overall.

The method according to the disclosure can now be used to simulate a huge number of parameter sets 207, which ultimately results in a parameter set 207C which generates the third speed profile G2C represented by a solid line. Unlike the technician on site, who, for example, after two attempts using stronger acceleration phases (increase in the steepness of the acceleration curve in the speed-time diagram), recognizes that the amplitudes 203 of the vibrations increase even more and he/she therefore leaves this path, even stronger acceleration phases can be tested without damage by means of the simulation on the simulation environment 250. This allows an optimal parameter set 207C to be determined, in which the zone of the natural frequency of the elastic system of elevator cab 43 and suspension device 31 is passed through as quickly as possible in this shaft section in the acceleration phase pa3. As a result, a higher speed V can also be achieved in the driving phase pt3. Depending on the configuration of the deceleration phase pd3, the travel time t becomes shorter, as represented by the travel time end t3. In order to increase the driving comfort of the users, the deceleration phase pd3 can also be configured and checked by simulations, if necessary, so that the end of the travel time t3 is equal to the end of the travel time t1.

Of course, these simulations can be automated or at least partially automated in the sense of an optimization routine 209. This can mean that the computer program product 109 is programmed in such a way that it automatically compares the results obtained by the simulations with the specified quality criteria ΔQ and applies change tendencies of the simulation results with the common, well-known stochastic methods, with fuzzy logic, etc. to determine the next parameter set 207 provided for the simulation. As soon as all predetermined quality criteria ΔQ are complied with by the simulation result, the optimization routine 209 can be ended and the determined parameters pa3, pt3, pd3 can be transferred to the parameter set 207 for the elevator control unit 41 of the existing or modernized elevator installation 11, which is coordinated for operation in the simulation environment 250.

In other words, the parameter set 207 is determined in the simulation environment 250 using an optimization routine 209 according to specifiable quality criteria ΔQ. The specified quality criteria ΔQ are, for example, tolerance specifications with regard to the maximum permissible vibration amplitudes of the suspension device 31 and acceleration phases pa1, pa2, pa3 and deceleration phases pv1, pv2, pv3 of the elevator cab 43 that are pleasant for the user of the elevator installation 11 with the shortest possible duration of the travel. International, regional, and national standards such as EN-81 can also define quality criteria ΔQ such as the maximum permissible acceleration, decelerations, waiting times, door opening and closing times, and the like. All of these movement sequences, determined by the parameter set 207 of the elevator control unit 41, of the various movable components of an existing or modernized elevator installation 11 can be simulated, checked and optimized in the simulation environment 250 available through the three-dimensional digital replica data record 111.

Although the present disclosure has been described in FIGS. 1 to 4 using the example of a simple existing elevator installation 11 and using a simple digital replica data record 111 which depicts it and which is only rudimentary with a few component model data records 112, it is obvious that the described method 151 and the corresponding system 1 are equally also used for elevator installations 11 of more complex design. Even if only one elevator cab 43 is described and shown in the figures, the system 1 according to the disclosure and the method 151 according to the disclosure can of course also be used in existing and modernized elevator installations 11 with a plurality of elevator cabs 43.

Finally, it should be noted that terms such as “having,” “comprising,” etc. do not preclude other elements or steps and terms such as “a” or “an” do not preclude a plurality. Furthermore, it should be noted that features or steps that have been described with reference to one of the above exemplary embodiments can also be used in combination with other features or steps of other embodiments described above. Reference numerals in the claims are not to be interpreted as delimiting.

1. A method for optimizing control data of the elevator control of an existing or modernized elevator installation, wherein the elevator control unit is connected to a programmable device, the method comprising:
loading a simulation environment based on a three-dimensional digital replica data record which can be generated by a computer program product, wherein the three-dimensional digital replica data record depicts and simulates the existing or modernized elevator installation associated with the elevator control unit,
setting a parameter set for the elevator control unit of the existing or modernized elevator installation which is coordinated for operation in the simulation environment is determined by testing the elevator control unit in the simulation environment, wherein the three-dimensional digital replica data record of the existing or modernized elevator installation is constructed from component model data records which comprise different configurations and are defined by characterizing properties,
approaching each floor level of the existing elevator installation at least once by at least one measuring run with the existing or to be modernized elevator installation,
recording at least those measurement data representing floor heights by a measuring device, wherein:
the component model data records configured as a floor section component model data record and/or the component model data records configured as a shaft section component model data record are arranged in a recorded sequence one above the other in the vertical direction for each floor level of the elevator installation detected by the measuring run, and
the default values of the characterizing property that defines the height distance with respect to the next component model data record are replaced in these component model data records in each case by the corresponding floor heights determined from the measurement data.

2. The method according to claim 1, wherein the three-dimensional digital replica data record of the existing or modernized elevator installation is generated by the computer program product from component model data records and stored in a storage medium, wherein each characterizing property is predefined by a default value, predetermined by a target value, or is determined by an actual value.

3. The method according to claim 1, wherein each floor section component model data record or each shaft section component model data record has predefined interfaces via which interfaces of component model data records can be connected to one another and positioned relative to one another, corresponding characterizing properties of each component model data record to be added being automatically replicated with the corresponding characterizing properties of the component model data record provided for the connection via the interface.

4. The method according to claim 1, wherein at least one component model data record configured as an elevator cab component model data record and one component model data record configured as a suspension device component model data record is arranged in a virtual shaft formed by at least one shaft section component model data record, the characterizing properties of which include at least parameters that can be changed during the execution of the method and are part of the parameter set to be determined.

5. The method according to any of claim 1, wherein the three-dimensional digital replica data record can be retrieved from a storage medium and can be represented on a screen dynamically reproducing at least the floor heights of the floor levels as a virtual elevator installation in correct relationship to one another and the parameter set of the elevator control unit.

6. The method according to claim 1, wherein via a graphical user interface, further component model data records of components of an elevator installation are selected from a database and via predefined interfaces can be inserted into the three-dimensional digital replica data record.

7. The method according to claim 6, wherein there can be selection of components from among at least counterweight, guide rail, shaft door, cab door, and suspension means component model data records as component model data records in different suspension means guiding options.

8. The method according to claim 1, wherein the characterizing properties defined by measurement data or customer-specific configuration data are provided with a designation so that they can be distinguished from characterizing properties with default values.

9. The method according to claim 8, wherein a component model data record of the three-dimensional digital replica data record can be replaced by a definitive component model data record by its characterizing properties provided with a designation being read out via an exchange routine, based on these designated, characterizing properties from a database possible definitive component model data records matching the characterizing properties of actually existing components of elevator installations are determined, and the replacing component model data record is additionally selected where appropriate by manual inputs.

10. The method according to claim 1, wherein the parameter set is determined in the simulation environment using an optimization routine according to specifiable quality criteria.

11. (canceled)

12. A computer-readable medium having stored thereon machine-readable instructions, which executed on a programmable device, cause the programmable device to carry out or control a method according to any of claim 1.
